(19) United States
(12) Patent Application Publication
(10) Pub. No.: US 2002/0019859 A1
(43) Pub. Date: Feb. 14, 2002

(54) Method and system for contents data processing service

(75) Inventor: Kouji Watanabe, Kanagawa (JP)

Correspondence Address: SUGHRUE, MION, ZINN, MACPEAK & SEAS, PLLC, 2100 Pennsylvania Avenue, NW, Washington, DC, 20037-3213, US

(73) Assignee: FUJI PHOTO FILM CO., LTD.

(21) Appl. No.: 09/919,617

(22) Filed: Aug. 1, 2001

(30) Foreign Application Priority Data
Aug. 1, 2000 (JP) 2000-232824

(51) Int. Cl. G06F 15/16

(52) U.S. Cl. 709/219; 709/203

(57) ABSTRACT

The method and system for contents data processing service transfer contents data from a terminal of an orderer to a processing apparatus of an order receiver via a communication line, process the transferred contents data in the processing apparatus of the order receiver and transfer processed contents data from the processing apparatus of the order receiver to the terminal of the orderer via the communication line and/or store and manage the processed contents data in a storage area of a data managing unit that is accessible from at least one of the terminal of the orderer and a terminal of a third party via the communication line.

### BACKGROUND OF THE INVENTION

1. Field of the Invention

The present invention relates to a method and a system for contents data processing service such as an image processing service utilizing a communication line such as the Internet. The service and the system of the present invention apply image processing to image data transmitted from a customer and return the processed image data to the customer such that the customer can take pleasure in high definition and high accuracy image processing, for example, image processing for professional photographers, which is applied to contents data such as digital image data captured in a customer terminal such as a personal computer of the customer without purchasing expensive dedicated hardware and/or software for image processing, receive an image processing service such as storage of contents data of an image after processing and opening to the public an image on a communication line such as the Internet and output a print on the customer's own printer.

2. Description of the Related Art

Conventionally, printing of an image, which is photographed on a photo film (hereinafter referred to as a film) such as a negative film and a reversal film, on a photosensitive material (photograph paper) was performed mainly by so-called direct exposure for projecting the image on the film to the photosensitive material to expose it.

On the other hand, in recent years, a printing apparatus utilizing digital exposure, that is, a digital photo-printer has been put into practical use. The digital photo-printer photoelectrically reads an image recorded on a film and converts the read image into digital signals, and then applies various kinds of image processing to digital image data being the digital signals to use as image data for recording, scans and exposes a photosensitive material by recording light modulated in response to this image data to record an image (latent image) and creates a (finished) print.

According to such a digital photo-printer, since an image can be processed (justified) by processing image data, image processing such as gradation adjustment, color balance adjustment and color/density adjustment can be preferably performed to realize a high definition print that could not have been realized by the conventional direct exposure. In addition, since an image is handled as digital image data, not only an image photographed on a film but also image data that is recorded as digital data on various recording media, for example, a CD-R, a magnetic recording medium such as a floppy disk and a removable hard disk (Zip, Jaz or the like), an MO disk (magneto-optical recording medium) and the like can be applied the image processing to be outputted as a print.

In addition, with spread of personal computers and color printers into homes, digitization of image data, low pricing of software for image processing by a personal computer, or the like, a simple image processing environment has been established in each home and editing and processing of a digital image can be performed freely. Thus, a customer applies image processing such as image composition and image editing to an image or the like, which the customer photographed by a digital still camera or the like, using image processing software on the customer's own personal computer and outputs a print by the customer's own printer.

However, image processing software used by a customer is not so excellent in quality. Thus, in order to obtain a high quality print which has been subjected to high accuracy and high definition image processing, all what the customer can do is to visit a laboratory to give image data, which applies image processing, for example, image processing for a professional photographer to the image data using dedicated expensive hardware and software in the laboratory and print an image to thereby realize a high quality print. This is not easy and convenient.

In order to solve this problem, the applicant has already proposed a method and a system for ordering and delivering a digital print, with which a customer can obtain a high quality print without visiting a laboratory shop, in the Japanese Patent Application Laid-open No. Hei 10-78618.

With this system, a customer applies image processing to image data, which is inputted from, for example, a digital camera or the like, by ordering software and image processing software downloaded from a laboratory using the customer's own personal computer or image processing software on the markets prepares order data and sends the image data after the image processing and the order data to the laboratory through a network. The laboratory then prepares a print based on the sent image data and order data to return the print to the customer by mailing, home delivery or over the counter.

However, although the method and the system disclosed in the Japanese Patent Application have an advantage indeed in that a customer can easily obtain a print without visiting a laboratory, the quality of image processing software on the market is not so high and image processing software downloaded from a laboratory is a simple one for easy use on a customer's personal computer as described above. Thus, since image processing performed on the personal computer of the customer has fewer types and items of image processing, a limited data amount that it can handle and a lower image density compared with high definition and high accuracy image processing, for example, image processing for professional photographers performed in a laboratory using expensive hardware and software, the method and the system have not been sufficiently improved in terms of an image quality.

As described above, in general, image processing software used by a customer is general purpose software, which takes limitations such as processing capability and processing speed of hardware into account, and is not always software that can optimally finish any image. In addition, it is difficult to select image processing software most suitable for an image to be an object of image processing and, even if most suitable image processing software can be selected, it is not easy to finish an image in such a manner that a customer who is not an expert is satisfied.

In addition, even if a user (customer) obtains image processing software, since it is not easy to handle it without any help, some users cannot even handle it. Even if a user can handle it, since know-how is required in order to finish an object image optimally, it is not easy to obtain an optimally finished image.

There already has been a technology for storing and managing a private image of a customer in a storage area of a server disposed over the Internet and opening the stored image to those who logging in using IDs and passwords. However, since an image opened to the public is processed by the customer using general purpose image processing software, it is not satisfactory at all.

### SUMMARY OF THE INVENTION

The present invention has been devised in view of the above-mentioned problems. Accordingly, it is an object of the present invention to provide a method and a system for contents data processing service such as an image processing service utilizing a communication line such as the Internet, with which a customer can easily and inexpensively take pleasure in high accuracy and high definition image processing, for example, image processing for professional photographers on the customer's own personal computer without purchasing expensive hardware and/or software dedicated to image processing, receive an image processing service such as storage of contents data of image after processing and opening to the public an image on a communication line such as the Internet and obtain a print of an image to which high accuracy and high definition image processing is applied on the customer's own printer.

Other objects and features of the present invention will be apparent from the following descriptions taken in conjunction with the accompanying drawings.

In order to attain the objects as described above, the first aspect of the present invention provides a method for contents data processing service, comprising the steps of: transferring contents data from a terminal of an orderer to a processing apparatus of an order receiver via a communication line; processing the transferred contents data in the processing apparatus of the order receiver; and transferring processed contents data from the processing apparatus of the order receiver to the terminal of the orderer via the communication line or storing and managing the processed contents data in a storage area of a data managing unit that is accessible from at least one of the terminal of the orderer and a terminal of a third party via the communication line, or both of said transferring of said processed contents data and said storing and managing of said processed contents data.

Preferably, the storage area of the data managing unit is accessed from at least one of the terminal of the orderer and the terminal of a third party via the communication line, whereby the processed contents data is received in the terminal of the orderer via the communication line.

Preferably, the communication line is Internet.

Preferably, the contents data is digital image data, the processing performed in the processing apparatus of the order receiver is image processing, and the processed contents data is digital image data that has been subjected to image processing.

Preferably, the digital image data is moving image data or still image data.

Preferably, the image processing is high definition image processing.

Preferably, the high definition image processing includes at least one of red-eye correction processing, defect erasing processing, dodging processing, lens aberration correction processing, fading correction processing, granulation restraining processing, sharpening processing, gradation correction processing, back light correction processing, RP style finish processing, cloth filter finish processing, soft focus finish processing, monotone finish processing, slender body finish processing, fair complexion finish processing and under/over correction processing.

Preferably, the processing apparatus of the order receiver transfers the processed digital image data to the terminal of the orderer via the communication line such that the processed digital image data can be outputted in an image output apparatus to be connected to the terminal of the orderer.

Preferably, the terminal of the orderer transfers with the digital image data at least one of information comprising input information of the digital image data and output information on the image output apparatus, and conditions comprising conditions of the image processing designated by the terminal of the orderer and finishing conditions of an image to be outputted from the image output apparatus.

Preferably, the processing apparatus of the order receiver applies image processing to the digital image data using at least one of the information comprising the input information and the output information, and the conditions comprising the conditions of image processing and the finishing conditions.

It is preferable that the method for the contents data processing service of the first aspect further comprises the step of: receiving the contents data sent from the terminal of the orderer and edit processing information in a receipt processing unit; and after receiving the contents data and the edit processing information in the receipt processing unit, the processing apparatus of the order receiver applies processing to the contents data using the edit processing information.

Preferably, the edit processing information includes information for instructing high definition image processing.

Preferably, the edit processing information includes at least one of character composition processing, certificate photograph processing, calendar processing, album processing, post card processing, business card processing, ticket processing, menu processing, template composition processing, mini-frame processing, card print processing and free trimming processing.

It is also preferable that the method for the contents data processing service of the first aspect further comprises the steps of: remotely logging in the processing apparatus of the order receiver from the terminal of the orderer; setting high definition image processing conditions with a GUI dedicated for the processing apparatus of the order receiver; sending digital image data as the contents data; and applying high definition image processing to the digital image data in the processing apparatus of the order receiver.

Preferably, the processing apparatus of the order receiver includes an image processing unit and a server, and the high definition image processing conditions are set with the GUI of the server.

Preferably, the digital image data is data that is digitized in image inputting apparatus of the orderer.

Preferably, the image inputting apparatus is a digital camera or a scanner.

Preferably, the image inputting apparatus can be set with the GUI dedicated for the processing apparatus of the order receiver, and image processing corresponding to the set image inputting apparatus can be performed.

Preferably, items and a degree of the high definition image processing can be set with the GUI dedicated for the processing apparatus of the order receiver.

Preferably, a method of receiving the processed contents data in the terminal of the orderer can be set with the GUI dedicated for the processing apparatus of the order receiver.

Preferably, the processing apparatus of the order receiver manages the orderer by an URL or an ID card.

Preferably, the processing apparatus of the order receiver determines a fee for a processing service according to used processing items and a data amount of the contents data and determines a fee for storing the processed contents data according to a period using a server for storing and managing the processed contents data and an area of use of the server, and the order receiver is billed these fees added to a fee for using the communication line from a connection service company of the communication line.

In order to attain the object described above, the second aspect of the present invention also provides a system for contents data processing service, comprising: a terminal of an orderer for transferring contents data via a communication line; a processing apparatus of an order receiver for processing the contents data transferred from the terminal of the orderer; and a first transferring device for transferring processed contents data from the processing apparatus of the order receiver to the terminal of the orderer via the communication line.

It is preferable that the system for the contents data processing service of the second aspect further comprises a data management apparatus for storing and managing processed contents data from the processing apparatus of the order receiver in a storage area accessible from the terminal of the orderer via the communication line.

The present invention further provides a system for contents data processing service, comprising: a terminal of an orderer for transferring contents data via a communication line; a processing apparatus of an order receiver for processing the contents data transferred from the terminal of the orderer; and a data management apparatus for storing and managing processed contents data of the processing apparatus of the order receiver in a storage area accessible from the terminal of the orderer via the communication line.

It is preferable that the system for the contents data processing service of the second and third aspects further comprises a receipt processing apparatus of an order receiver for receiving the contents data transferred from the terminal of the orderer and edit processing information.

Preferably, in the second and third aspects, the storage area of the data managing unit is accessed from the terminal of the orderer via the communication line, whereby the processed contents data is received in the terminal of the orderer via the communication line.

It is also preferable that the system for the contents data processing service of the second and third aspects further comprises an image outputting apparatus which is connected to the terminal of the orderer and outputs the processed contents data as a visible image.

It is further preferable that the system for the contents data processing service of the second and third aspects further comprises at least one of an information inputting device for inputting input information of the contents data and a conditions inputting device for inputting conditions of image processing and finishing conditions of contents to be outputted; and a second transferring device for transferring the processed content data to the terminal of the orderer via the communication lines and the first transferring device transfers with the contents data at least one of the input information and conditions comprising the conditions for image processing and the finishing conditions via the communication line, and the processing apparatus of the order receiver receives with the transferred contents data at least one of the input information and the conditions comprising the conditions of image processing and the finishing conditions and applies the image processing to the contents data using at least one of the input information and the conditions comprising the conditions of image processing and the finishing conditions.

Preferably, the information inputting device inputs output information on the image outputting apparatus, the conditions inputting device inputs the finishing conditions of an image to be outputted from the image outputting apparatus, the first transferring device transfers with the contents data at least one of information comprising the input information and the output information and conditions comprising the conditions for image processing and the finishing conditions via the communication line, and the processing apparatus of the order receiver receives with the transferred contents data at least one of the information comprising the input information and the output information and the conditions comprising the conditions of image processing and the finishing conditions and applies the image processing to the contents data using at least one of the information comprising the input information and the output information and the conditions comprising the conditions of image processing and the finishing conditions.

It is still further preferable that the system for the contents data processing service of the second and third aspects further comprises an image inputting device for inputting the contents data.

Preferably, the communication line is Internet.

Preferably, the contents data is digital image data, the processed contents data is digital image data that has been subjected to image processing, and the processing apparatus of the order receiver performs image processing as the processing.

Preferably, the digital image data is moving image data or still image data.

Preferably, the image processing is high definition image processing.

Preferably, the high definition image processing includes at least one of red-eye correction processing, defect erasing processing, dodging processing, lens aberration correction processing, fading correction processing, granulation restraining processing, sharpening processing, gradation correction processing, back light correction processing, RP style finish processing, cloth filter finish processing, soft focus finish processing, monotone finish processing, slender body finish processing, fair complexion finish processing and under/over correction processing.

Preferably, the edit processing information includes information for instructing high definition image processing.

Preferably, the edit processing information includes at least one of character composition processing, certificate photograph processing, calendar processing, album processing, post card processing, business card processing, ticket processing, menu processing, template composition processing, mini-frame processing, card print processing and free trimming processing.

Preferably, high definition image processing conditions are set with a GUI dedicated for the processing apparatus of the order receiver by logging remotely in the processing apparatus of the order receiver from the terminal of the orderer, and high definition image processing is applied to digital image data sent as the contents data from the terminal of the orderer in accordance with the set high definition image processing conditions in the processing apparatus of the order receiver.

Preferably, the processing apparatus of the order receiver includes an image processing unit and a server, and the high definition image processing conditions are set with the GUI of the server.

Preferably, the digital image data is data that is digitized in image inputting apparatus of the orderer.

Preferably, the image inputting apparatus is a digital camera or a scanner.

Preferably, the image inputting apparatus can be set with the GUI dedicated for the processing apparatus of the order receiver, and image processing corresponding to the set image inputting apparatus can be performed.

Preferably, items and a degree of the high definition image processing can be set with the GUI dedicated for the processing apparatus of the order receiver.

Preferably, a system of receiving the processed contents data in the terminal of the orderer can be set with the GUI dedicated for the processing apparatus of the order receiver.

Preferably, the processing apparatus of the order receiver manages the orderer by an URL or an ID card. Preferably, the processing apparatus of the order receiver determines a fee for a processing service according to used processing items and a data amount of the contents data and determines a fee for storing the processed contents data according to a period using a server for storing and managing the processed contents data and an area of use of the server in case of storing the processed contents data in the server, and these determined fees are charged in addition to a fee for using the communication line from a connection service company of the communication line.

### BRIEF DESCRIPTION OF THE DRAWINGS

In the accompanying drawings:

FIG. 1 is a schematic view showing an embodiment of an image processing service system utilizing a network in accordance with the present invention;

FIG. 2 is a schematic view showing another embodiment of an image processing service system utilizing a network in accordance with the present invention;

FIG. 3 is an examplanatory view schematically illustrating an example of a GUI of an image processing server of the image processing service system shown in FIG. 2; and

FIG. 4 is a schematic view showing still another embodiment of the image processing service system utilizing a network in accordance with the present invention.

### DETAILED DESCRIPTION OF THE PREFERRED EMBODIMENTS

A method and a system for a contents data processing service in accordance with the present invention will be hereinafter described in detail based on preferred embodiments shown in the accompanying drawings.

Further, a system for a contents data processing service for embodying a method for contents data processing service in accordance with the present invention will be described with an image processing service system for embodying an image processing service method utilizing the Internet as a representative example. However, it is needless to mention that the present invention is not limited to this.

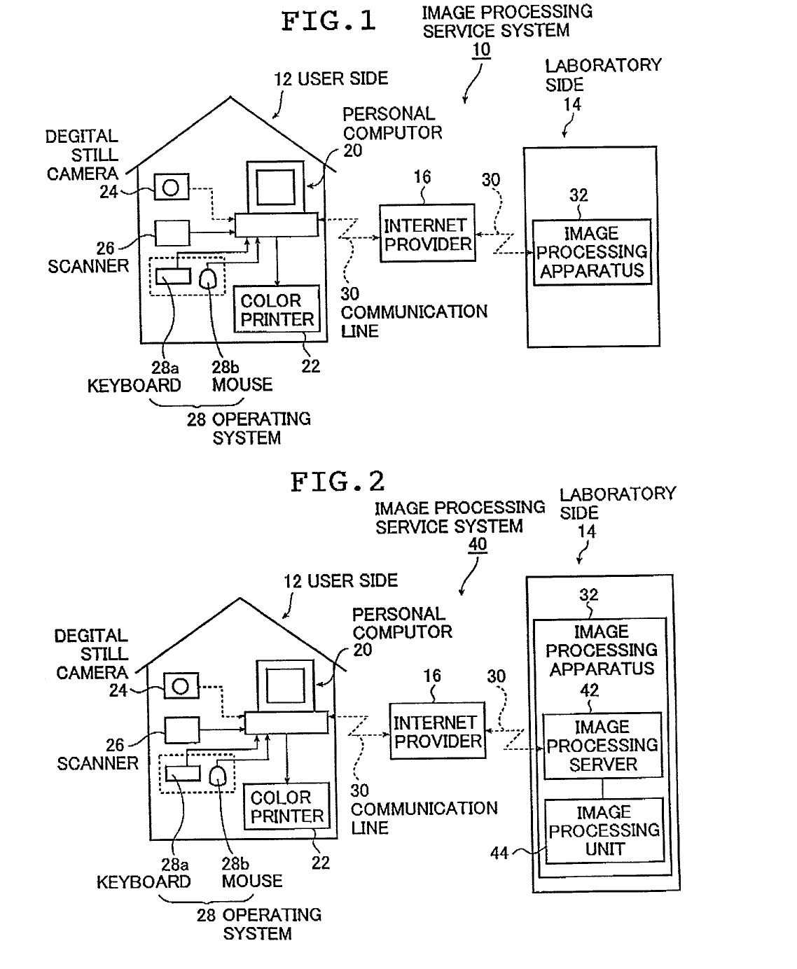

FIG. 1 is a schematic view showing a first embodiment of the image processing service system in accordance with the present invention, which utilizes a network such as the Internet. An image processing service system 10 utilizing the network is substantially composed of a customer or a user (orderer) 12 side, a laboratory (an image processing service company, an order receiver) 14 side and an Internet provider (a connection service company of a communication line) 16 that connects the foregoing.

On the user 12 side, a personal computer (orderer's terminal) 20 and a color printer (image output apparatus) 22 are provided. The personal computer 20 on the user 12 side is composed of a personal computer main body, a display, a memory, a modem and the like. In addition to these, a digital still camera 24 or a scanner 26 or, although not shown, a digital video camera or a driver of image recording media such as an MO, an FD and a CD-R and the like is connected to the personal computer 20 as an image inputting device. Further, an operating system 28 including a keyboard 28a, a mouse 28b, and the like is also connected to the personal computer 20 for operating it or inputting data in it.

In addition, a communication line 30 such as a wire or wireless public telephone line is connected to a modem of the personal computer 20. The personal computer 20 is connected to an image processing apparatus 32 provided on the laboratory 14 side via the Internet provider 16 through this communication line 30.

In addition, a printer driver installed in advance into the personal computer 20 on the user 12 side, so that Internet image processing can be performed in the image processing apparatus 32 on the laboratory 14 side. Thus, the user 12 can automatically or manually set whether the user 12 connects the personal computer 20 to the laboratory 14 side to which an image processing service via the Internet is provided.

In the first embodiment of the present invention, when a user sends image data to a laboratory side via the Internet, high accuracy and high definition image processing is applied to the image data in the laboratory and the image data is returned to the user via the Internet again to be printed out in the user's own printer.

An operation of the first embodiment of the present invention and an example of the image processing service method utilizing a network of the present invention will be hereinafter described.

First, the user 12 inputs image data in the user's own personal computer 20. The image inputting device is not specifically limited and may be the digital still camera 24 or may be the scanner 26. The scanner 26 may be a scanner for reading image data from a reflecting original such as a print photograph and printed matter to form digital image data or may be a film scanner for reading image data from a transparent original such as a photograph film.

The user 12 then connects the personal computer 20 to an image processing service provider using a printer driver installed therein in advance, which allows the personal computer 20 to make connection to Internet image processing. That is, when the personal computer 20 executes a print command of the printer driver, image data on the personal computer 20 is automatically transferred to the laboratory 14 side through the Internet. At this point, input information and output information of the image data are also transferred together with the image data to be used in image processing on the laboratory 14 side.

Further, the user 12 can perform image processing on the user's own personal computer 20 to directly print out image data to the printer 22 instead of starting the printer driver to make connection to the Internet image processing service.

The input information of image data to be transferred together with the above-mentioned image data includes information on the image inputting device, its type, an environment at the time of photographing an image (use or nonuse of a strobe, etc.) or the like, and the output information includes information on the type of an image outputting apparatus, etc. These pieces of information may be inputted in the personal computer 20 by the user 12 using the operating system 18. However, the pieces of information are automatically transferred together with the image data if the personal computer 20 is set in advance to perform this. Further, photographing information or the like is automatically recorded at the time of photographing together with the image data if an image is photographed using the digital still camera 24.

Optimal image processing adapted to the user's printer can be performed by sending these pieces of information to the laboratory 14 side together with the image data.

In addition, when transferring the above-mentioned input/output information, the user 12 can also designate image processing conditions and finishing conditions of an output image in detail to transfer the conditions manually together with the information or instead of the information. In this way, not only processing adapted to the image inputting device and the image outputting device used by the user 12 is simply performed but also image processing for preparing a print that actually satisfies desires of the user 12 can be performed.

The image processing conditions/finishing conditions are not specifically limited and are related to, for example, sharpness, gradation, density, color, dodging, partial correction or the like and are designated by the user 12 inputting a degree of each processing from the operating system 28.

The laboratory 14 side, which has received the image data, applies high accuracy image processing to the image data using the input/output information or the image processing conditions/finishing conditions transferred together with the image data. When the image processing is performed using the input/output information, processing conditions according to a type of inputting/outputting devices are set in advance, based on which the image processing is performed.

Here, a case in which dodging is performed will be described as an example of the image processing.

The dodging is for giving normal exposure to an area with an intermediate density in a scene, selectively giving a long time exposure to an area that is likely to cause white void on a print and selectively making an exposure time short for an area that is likely to cause black solid on a prints thereby maintaining a contrast of an individual subjected and obtaining a print without making a light part washed out and a dark part dull.

The dodging processing using digital image data is for preparing a blurred image signal from digital image data to realize a dodging effect by adding the blurred image signal to the original digital image data.

Digital image data is first converted to a density signal, and gray balance processing, brightness correction processing and gradation correction processing are applied to the density signal. The image signal which has been subjected to the processing is then subjected to color correction such that the image signal becomes a signal of colors that are reproduced appropriately on a print (photosensitive material). The corrected signal is converted to a brightness or luminace (light and dark) signal. A blurred image signal is prepared by, for example, thinning out a part of the brightness (light and dark) signal.

In addition, sharpness processing or the like is applied to original digital processing data in advance if necessary. Then, a dodging effect can be realized by adding the blurred image signal prepared as described above to the original digital image data.

In addition, other image processing is performed if necessary in the image processing apparatus 32 on the laboratory 14 side. Then, the image data is finally converted to a format optimal for an output of the printer 22 of the user 12.

The image data after the image processing is returned to the user 12 side through the Internet again. Upon receiving the image data after the image processing, the user 12 outputs it from the printer 22, whereby a finished print desired by the user 12 can be obtained.

The above-mentioned dodging processing using a blurred image signal is usually performed by an apparatus such as a large scale digital photo-printer. It is difficult for a user to perform the dodging processing using a personal computer or the like in the user's home.

In addition, on the other hand, performance of a color printer has been extremely improved in recent years. Thus, a user sends image data to a laboratory, high accuracy image processing is performed using a large scale apparatus with high performance in the laboratory, and image data after the image processing is returned to the user. Thereafter, the user prints the image data with the user 's printer, whereby the user can easily and inexpensively obtain a high quality finished print, which has been subjected to high accuracy image processing, with the user's own personal computer and printer as described in this embodiment.

In this case, image input information such as a type of a camera with which an image has been photographed and a situation in which an image has been photographed and image output information such as a type of a printer are sent to the laboratory side, whereby image processing optimal with respect to the information is applied to the image data with an image processing apparatus in the laboratory and the image data is returned to the user. As a result, the user can easily obtain a high quality print simply by performing photographing and printing.

In addition, a fee for using this image processing service is charged at a stage in which a user makes connection to the Internet image processing and is added to a fee for using the Internet to be billed from the Internet provider 16. The fee for using the image processing service may be paid by, for example, being automatically charged to a bank account of a user together with the fee for using the Internet. It does not require any specific attention and labor and is easy.

The fee is preferably displayed for each processing (service) when the processing is selected on a screen of the personal computer 20.

As described above in detail, according to this embodiment, a user can easily obtain a high quality print by simply transferring an image utilizing the Internet without being required to visit a laboratory.

An image processing service system for embodying an image processing service method utilizing a network of a second embodiment of the present invention will now be described.

FIG. 2 shows a schematic view of the image processing service system of this embodiment.

In an image processing service system 40 shown in FIG. 2, an image processing service is performed. First, image data is transmitted from the personal computer 20 on the user 12 side through the Internet and is subjected to image processing in the image processing apparatus 32 on the laboratory 14 side. Then, digital image data that has been subjected to the image processing (hereinafter referred to as processed image data) is returned to the personal computer 20 on the user 12 side or the processed image data is stored and managed on the laboratory 14 side. Alternatively, the processed image data is return to the user 12 side and at the same time stored and managed on the laboratory 14 side.

As described above, the image processing service system 10 shown in FIG. 1 transmits image data through the Internet without making a user aware, that is, automatically, by a print instruction in the personal computer 20 on the user 12 side. The image data is subjected to an image processing service in the image processing apparatus 32 of the laboratory 14 and, then, the image processing service system 10 receives the image data through the Internet again to output the image, which has been subjected to the image processing on the laboratory 14 side, with the printer 22 on the user 12 side.

Therefore, the image processing service system 40 shown in FIG. 2 is similar to the image processing service system 10 shown in FIG. 1 except that processed image data is stored and managed on the laboratory 14 side and that processed image data returned to the user 12 side is not automatically printed and outputted with the printer 22. Thus, identical reference numerals are assigned to identical elements and their descriptions are omitted, and the laboratory 14 side will be mainly described.

In the image processing service system 40 shown in FIG. 2, the image processing apparatus 32 on the laboratory 14 side has an image processing server 42 and an image processing unit 44.

Here, the image processing unit 44 applies image processing, in particular, high accuracy and high definition image processing that is performed in the image processing apparatus 32 of the image processing service system shown in FIG. 1 to an image. In addition, the image processing unit 44 can also perform image edit processing such as composition, editing or the like of images as image processing.

The high definition image processing that can be performed in the image processing unit 44 can be exemplified by at least one of red-eye correction processing, defect erasing processing, dodging processing, lens aberration correction processing, fading correction processing, granulation restraining processing, sharpening processing, gradation correction processing, back light correction processing, RP style finish processing, cloth filter finish processing, soft focus finish processing, monotone finish processing, slender body finish processing, fair complexion finish processing, under/over correction processing and the like.

In addition, the image edit processing can be exemplified by at least one of character composition processing, photograph for certificate processing, calendar processing, album processing, post card processing, business card processing, ticket processing, menu processing, template composition processing, mini-frame processing, card print processing, free trimming processing and the like.

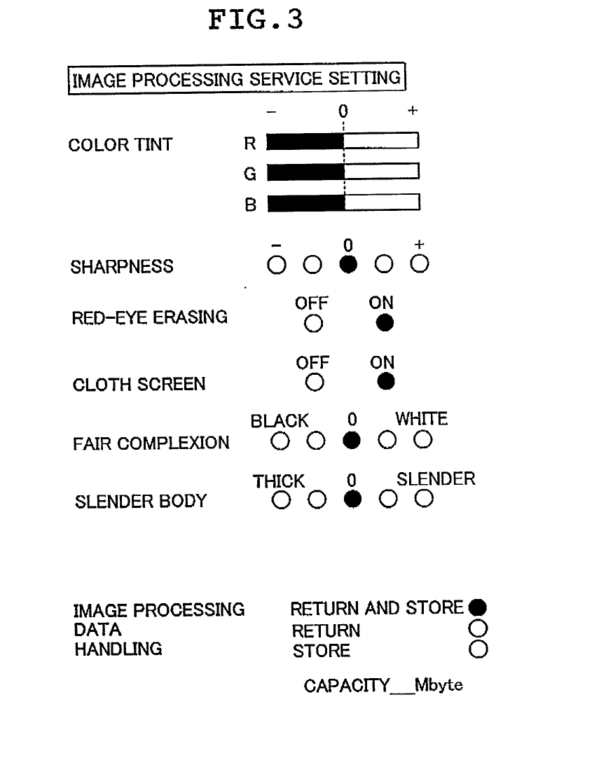

The image processing server 42 can set conditions of high accuracy and high definition image processing, editing conditions or the like desired by a user which should be applied in the image processing unit 44 in a laboratory shop to image data sent by the user using a dedicated GUI shown in FIG. 3 by remotely logging in from the personal computer 20 on the user 12 side through the Internet.

FIG. 3 shows an example of the GUI of the image processing server 42. With this GUI, an image inputting apparatus on the user 12 side such as the digital camera 24 and the scanner 26 can be set, and the image processing unit 44 can perform image processing corresponding to the setting.

In addition, with the GUI shown in FIG. 3, details of image processing and a finish condition of a print, for example, sharpness and color tint can be set. Further, “red-eye elimination”, “defect elimination”, “cloth filter processing”, “slender body finish”, “fair complexion finish” and the like can be set as image processing for professional photographers. Moreover, with this GUI, intensity and a degree for applying the image processing can be set in a few stages.

In addition, the image processing server 42 has both functions of storing and managing processed image data which has been subjected to image processing in the image processing unit 44 and returning the image data to the personal computer 20 on the user 12 side through the Internet.

The image data that has been subjected to image processing in the image processing unit 44 is stored in a rental/lease area of a medium or a drive of the image processing server 42 in the laboratory shop as desired by the user and can be downloaded if necessary. In addition, the image data can be transmitted to the personal computer 20 on the user 12 side through the Internet after the image processing by the image processing unit 44.

Further, concerning handling of processed image data, only storage or retuning of image data can be set or storage and returning of image data can be set in the GUI of the image processing server 42 shown in FIG. 3.

Moreover, the image processing server 42 may also store and manage image data to be transmitted through the Internet from the personal computer 20 on the user 12 side and information such as composition and editing of image processing applied to this image data.

Moreover, conditions of high accuracy and high definition image processing, in particular, conditions or the like of image processing (editing information) which cannot be set by a dedicated GUI may also be stored and managed in the image processing server 42 from the personal computer 20 on the user 12 side.

In the image processing apparatus 32 on the laboratory 14 side, it is desirable that a user is identified by a URL or an ID card and image data, processed image data, edit processing information such as image processing and edit processing or the like of the user are managed using the URL or the ID card of the identified user.

In this embodiment, it is desirable that an image processing service fee to be charged by the laboratory 14 side is determined according to used items of image processing and image data amount both in the case of storage of processed data and the case of returning of processed data. In addition, it is desirable that, in the case of storage, a storage fee is further determined based on a period for which a drive for storage is used and an area of use of the drive, which are added to the fee for using the Internet to be billed from the Internet provider 16.

In this way, in the image processing service system 40 shown in FIG. 2, an image processing service can be performed. First, a user remotely logs in the image processing server 42 of the image processing apparatus 32 through the Internet from the personal computer 20 on the user 12 side, sets an image processing method with an image processing GUI and uploads image data through the Internet. The image data is then subjected to image processing in the image processing unit 44 of the image processing apparatus 32 on the laboratory 14 side, and processed image data is returned to the personal computer 20 on the user 12 side or stored and managed in the rental/lease area (drive) of the image processing server 42 on the laboratory 14 side. Alternatively, the processed image data is returned to the user 12 side and at the same time stored and managed on the laboratory 14 side.

In addition, this service fee can be billed through the Internet provider 16 according to image processing items or a drive store period/area.

An image processing service system for embodying an image processing service method utilizing a network of a third embodiment of the present invention will now be described.

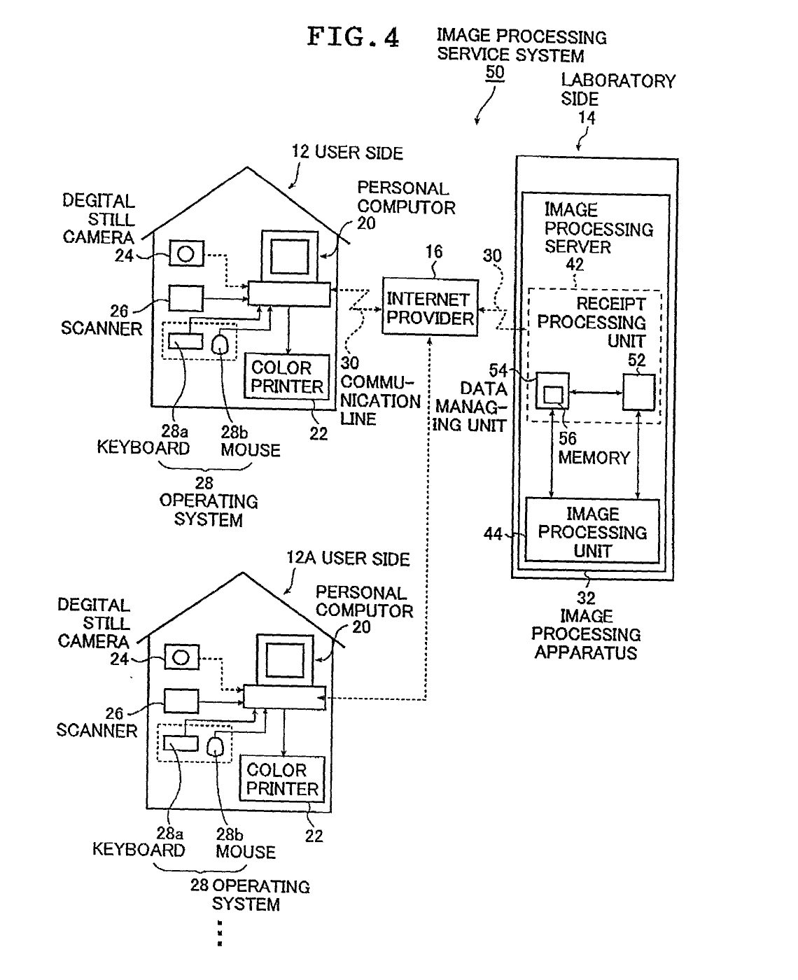

FIG. 4 shows a schematic illustration of the image processing service system of this embodiment.

An image processing service system 50 shown in FIG. 4 is similar to the image processing service system shown in FIG. 2 except that the image processing server 42 includes a receipt processing unit 52 and a data managing unit 54 and the data managing unit 54 includes a memory 56 having an area opened to the user 12 who is a person concerned (an owner of image data), a user 12A who is a third party and the like and that image data and edit processing information of the user 12 are transmitted from the personal computer 20 on the user 12 side to the receipt processing unit 52. Thus, identical reference numerals are assigned to identical elements and their descriptions are omitted, and differences are mainly described.

In the image processing service system 50 shown in FIG. 4, the image processing apparatus 32 on the laboratory 14 side includes the image processing server 42 and the image processing unit 44, the image processing server 42 is provided with the reception processing unit 52 and the data managing unit 54, and the data managing unit 54 includes a memory 56.

Here, the reception processing unit 52 has a function of receiving digital image data (hereinafter also referred to simply as image data) of the user transmitted from the personal computer 20 on the user 12 side through the Internet (the provider 16 and the communication line 30) and edit processing information of this image data, for example, image processing information of image processing items and intensity (degree), and editing information such as composition and editing of an image. Moreover, the reception processing unit 52 also has a function of transferring received image data and its edit processing information to the image processing unit 44 and receiving processed image data that has been subjected to desired image processing in the image processing unit 44 to return it to the personal computer 20 on the user 12 side through the Internet. In this case, it is preferable that the image data received by the receipt processing unit 52 and its edit processing information as well as the processed image data are associated with information of a URL and an ID card of the user.

The data managing unit 54 stores and manages processed image data temporarily or for a predetermined period, which has been subjected to desired image processing in the image processing unit 44. It is preferable that the processed image data is stored in the memory 56 such as a medium and a drive if storage of processed image data for a predetermined period is required by a request or the like of the user. Here, the memory 56 may be a built-in memory of the image processing server 42 or may be an external memory.

Further, in this embodiment, the memory 56 of the data managing unit 54 includes a storage area in which processed image data is stored and managed. This storage area is a storage area that is accessible from the personal computer 20 on the user 12 side via the Internet. The user 12A who is a third party permitted to access can access this storage area through the receipt processing unit 52 on the laboratory 14 side.

In this way, in this embodiment, the user 12 is made to store a private image of the user 12 which has been subjected to high accuracy and high definition image processing, for example, so-called image processing for professional photographers, in the storage area in the memory 56 of the data managing unit 54 of the image processing server 42 placed over the Internet, whereby the image can be opened to those who log in the image processing server 42 using IDs and passwords (not only the user but also a third party permitted to access the server).

As a result, even a user who has not become skilled in image processing can open to the public the user's own digital image data that has been subjected to high accuracy and high definition image processing, for example, so-called image processing for professional photographers, over the Internet to have many people take pleasure in seeing it.

In each of the above-mentioned embodiments, image data is not specifically restrictive and may be image data of a still image or image data of a moving image as long as it is digital image data. Further, in the present invention, contents are not specifically restrictive and may be sounds and voices, music or the like, but are preferably an image such as a moving image, a still image or the like as described above.

In the present invention, a format of image data of a still image that is transmitted and received over the Internet is not specifically restrictive, and a publiclywell-known format such as the JPEG, the GIF or the TIFF is preferably used. In addition, a format of image data of a moving image that is transmitted and received over the Internet is not specifically restrictive, and a publiclywell-known format such as MPEG, for example, the MPEG1, the MPEG2, the MPEG4 and the MPEG7, in particular the MPEG4 and the MPEG7 are preferably used.

Thus, the method and the system for contents data processing service of the present invention have been described in detail with various embodiments of the image processing service method and system utilizing the Internet as examples. However, it is needless to mention that the present invention is not limited to the above embodiments and various improvements and modifications may be made as long as such improvements and modifications do not depart from the spirit and the scope of the present invention.

As described above, according to the present invention, a user can easily and inexpensively obtain a print that has been subjected to high accuracy and high definition image processing, for example, so-called image processing for professional photographers with the user's own personal computer and printer.

In addition, according to the present invention, in addition to the above-mentioned effect, a user can enjoy an image processing service with which the user can easily take pleasure in high accuracy and high definition image processing without purchasing expensive dedicated hardware/software for image processing and can also select and set a method of handling image data after processing as the user desires.

Moreover, according to the present invention, in addition to the above-mentioned effects, a user can obtain image processing service that is a combination of storage and opening to the public over the Internet of image data which has been subjected to laboratory high accuracy and high definition image processing, for example, so-called image processing for professional photographers.

Thus, it is seen that a method and a system for contents data processing service are provided. One skilled in the art will appreciate that the present invention can be practiced by other than the preferred embodiments which are presented for the purposes of illustration and not of limitation, and the present invention is limited only by the claims which follow.

What is claimed is:

1. A method for contents data processing service, comprising the steps of:
transferring contents data from a terminal of an orderer to a processing apparatus of an order receiver via a communication line;
processing said transferred contents data in said processing apparatus of the order receiver; and
transferring processed contents data from said processing apparatus of the order receiver to said terminal of the orderer via said communication line or storing and managing said processed contents data in a storage area of a data managing unit that is accessible from at least one of said terminal of the orderer and a terminal of a third party via said communication line, or both of said transferring of said processed contents data and said storing and managing of said processed contents data.

2. The method according to claim 1, wherein said storage area of said data managing unit is accessed from at least one of said terminal of the orderer and said terminal of a third party via said communication line, whereby said processed contents data is received in said terminal of the orderer via said communication line.

3. The method according to claim 1, wherein said communication line is Internet.

4. The method according to claim 1, wherein said contents data is digital image data, said processing performed in said processing apparatus of the order receiver is image processing, and said processed contents data is digital image data that has been subjected to image processing.

5. The method according to claim 4, wherein said digital image data is moving image data or still image data.

6. The method according to claim 4, wherein said image processing is high definition image processing.

7. The method according to claim 6, wherein said high definition image processing includes at least one of red-eye correction processing, defect erasing processing, dodging processing, lens aberration correction processing, fading correction processing, granulation restraining processing, sharpening processing, gradation correction processing, back light correction processing, RP style finish processing, cloth filter finish processing, soft focus finish processing, monotone finish processing, slender body finish processing, fair complexion finish processing and under/over correction processing.

8. The method according to claim 4, wherein said processing apparatus of the order receiver transfers said processed digital image data to said terminal of the orderer via said communication line such that said processed digital image data can be outputted in an image output apparatus to be connected to said terminal of the orderer.

9. The method according to claim 8, wherein said terminal of the orderer transfers with said digital image data at least one of information comprising input information of said digital image data and output information on said image output apparatus, and conditions comprising conditions of said image processing designated by said terminal of the orderer and finishing conditions of an image to be outputted from said image output apparatus.

10. The method according to claim 9, wherein said processing apparatus of the order receiver applies image processing to said digital image data using at least one of said information comprising said input information and said output information, and said conditions comprising said conditions of image processing and said finishing conditions.

11. The method according to claim 1, further comprising the step of:
receiving said contents data sent from said terminal of the orderer and edit processing information in a receipt processing unit; wherein
after receiving said contents data and said edit processing information in said receipt processing unit, said processing apparatus of the order receiver applies processing to said contents data using said edit processing information.

12. The method according to claim 11, wherein said edit processing information includes information for instructing high definition image processing.

13. The method according to claim 11, wherein said edit processing information includes at least one of character composition processing, certificate photograph processing, calendar processing, album processing, post card processing, business card processing, ticket processing, menu processing, template composition processing, mini-frame processing, card print processing and free trimming processing.

14. The method according to claim 1, further comprising the steps of:
remotely logging in said processing apparatus of the order receiver from said terminal of the orderer;
setting high definition image processing conditions with a GUI dedicated for said processing apparatus of the order receiver;
sending digital image data as said contents data; and
applying high definition image processing to said digital image data in said processing apparatus of the order receiver.

15. The method according to claim 14, wherein said processing apparatus of the order receiver includes an image processing unit and a server, and said high definition image processing conditions are set with said GUI of said server.

16. The method according to claim 14, wherein said digital image data is data that is digitized in image inputting apparatus of the orderer.

17. The method according to claim 16, wherein said image inputting apparatus is a digital camera or a scanner.

18. The method according to claim 16, wherein said image inputting apparatus can be set with said GUI dedicated for said processing apparatus of the order receiver, and image processing corresponding to said set image inputting apparatus can be performed.

19. The method according to claim 14, wherein items and a degree of said high definition image processing can be set with said GUI dedicated for said processing apparatus of the order receiver.

20. The method according to claim 14, wherein a method of receiving said processed contents data in said terminal of the orderer can be set with said GUI dedicated for said processing apparatus of the order receiver.

21. The method according to claim 1, wherein said processing apparatus of the order receiver manages said orderer by an URL or an ID card.

22. The method according to claim 1, wherein said processing apparatus of the order receiver determines a fee for a processing service according to used processing items and a data amount of said contents data and determines a fee for storing said processed contents data according to a period using a server for storing and managing said processed contents data and an area of use of the server, and said order receiver is billed these fees added to a fee for using said communication line from a connection service company of said communication line.

23. A system for contents data processing service, comprising:
a terminal of an orderer for transferring contents data via a communication line;
a processing apparatus of an order receiver for processing said contents data transferred from said terminal of the orderer; and
a first transferring device for transferring processed contents data from said processing apparatus of the order receiver to said terminal of the orderer via said communication line.

24. The system according to claim 23, further comprising a data management apparatus for storing and managing processed contents data from said processing apparatus of the order receiver in a storage area accessible from said terminal of the orderer via said communication line.

25. A system for contents data processing service, comprising:
a terminal of an orderer for transferring contents data via a communication line;
a processing apparatus of an order receiver for processing said contents data transferred from said terminal of the orderer; and
a data management apparatus for storing and managing processed contents data of said processing apparatus of the order receiver in a storage area accessible from said terminal of the orderer via said communication line.

26. The system according to claim 23 or 25, further comprising a receipt processing apparatus of an order receiver for receiving said contents data transferred from said terminal of the orderer and edit processing information.

27. The system according to claim 26, wherein said storage area of said data managing unit is accessed from said terminal of the orderer via said communication line, whereby said processed contents data is received in said terminal of the orderer via said Communication line.

28. The system according to claim 23 or 25, further comprising an image outputting apparatus which is connected to said terminal of the orderer and outputs said processed contents data as a visible image.

29. The system according to any one of claim 23 or 25, further comprising:
at least one of an information inputting device for inputting input information of said contents data and a conditions inputting device for inputting conditions of image processing and finishing conditions of contents to be outputted; and
a second transferring device for transferring said processed content data to said terminal of the orderer via said communication line,
wherein said first transferring device transfers with said contents data at least one of said input information and conditions comprising said conditions for image processing and said finishing conditions via said communication line, and said processing apparatus of the order receiver receives with said transferred contents data at least one of said input information and said conditions comprising said conditions of image processing and said finishing conditions and applies said image processing to said contents data using at least one of said input information and said conditions comprising said conditions of image processing and said finishing conditions.

30. The system according to claim 29, wherein said information inputting device inputs output information on said image outputting apparatus, said conditions inputting device inputs said finishing conditions of an image to be outputted from said image outputting apparatus, said first transferring device transfers with said contents data at least one of information comprising said input information and said output information and conditions comprising said conditions for image processing and said finishing conditions via said communication line, and said processing apparatus of the order receiver receives with said transferred contents data at least one of said information comprising said input information and said output information and said conditions comprising said conditions of image processing and said finishing conditions and applies said image processing to said contents data using at least one of said information comprising said input information and said output information and said conditions comprising said conditions of image processing and said finishing conditions.

31. The system according to claim 23 or 25, further comprising an image inputting device for inputting said contents data.

32. The system according to claim 23 or 25, wherein said communication line is Internet.

33. The system according to claim 23 or 25, wherein said contents data is digital image data, said processed contents data is digital image data that has been subjected to image processing, and said processing apparatus of the order receiver performs image processing as said processing.

34. The system according to claim 33, wherein said digital image data is moving image data or still image data.

35. The system according to claim 33, wherein said image processing is high definition image processing.

36. The system according to claim 35, wherein said high definition image processing includes at least one of red-eye correction processing, defect erasing processing, dodging processing, lens aberration correction processing, fading correction processing, granulation restraining processing, sharpening processing, gradation correction processing, back light correction processing, RP style finish processing, cloth filter finish processing, soft focus finish processing, monotone finish processing, slender body finish processing, fair complexion finish processing and under/over correction processing.

37. The system according to claim 26, wherein said edit processing information includes information for instructing high definition image processing.

38. The system according to claim 26, wherein said edit processing information includes at least one of character composition processing, certificate photograph processing, calendar processing, album processing, post card processing, business card processing, ticket processing, menu processing, template composition processing, mini-frame processing, card print processing and free trimming processing.

39. The system according to claim 23 or 25, wherein
high definition image processing conditions are set with a GUI dedicated for said processing apparatus of the order receiver by logging remotely in said processing apparatus of the order receiver from said terminal of the orderer, and
high definition image processing is applied to digital image data sent as said contents data from said terminal of the orderer in accordance with said set high definition image processing conditions in said processing apparatus of the order receiver.

40. The system according to claim 39, wherein said processing apparatus of the order receiver includes an image processing unit and a server, and said high definition image processing conditions are set with said GUI of said server.

41. The system according to claim 39, wherein said digital image data is data that is digitized in image inputting apparatus of the orderer.

42. The system according to claim 41, wherein said image inputting apparatus is a digital camera or a scanner.

43. The system according to claim 41, wherein said image inputting apparatus can be set with said GUI dedicated for said processing apparatus of the order receiver, and image processing corresponding to said set image inputting apparatus can be performed.

44. The system according to claim 39, wherein items and a degree of said high definition image processing can be set with said GUI dedicated for said processing apparatus of the order receiver.

45. The method according to claim 39, wherein a system of receiving said processed contents data in said terminal of the orderer can be set with said GUI dedicated for said processing apparatus of the order receiver.

46. The system according to claim 23 or 25, wherein said processing apparatus of the order receiver manages said orderer by an URL or an ID card.

47. The system according to claim 23 or 25, wherein said processing apparatus of the order receiver determines a fee for a processing service according to used processing items and a data amount of said contents data and determines a fee for storing said processed contents data according to a period using a server for storing and managing said processed contents data and an area of use of the server in case of storing said processed contents data in the server, and these determined fees are charged in addition to a fee for using said communication line from a connection service company of said communication line.
